(19) United States
(12) Patent Application Publication
(10) Pub. No.: US 2016/0352045 A1
(43) Pub. Date: Dec. 1, 2016

(54) CONNECTOR PLUG

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: LE YU, Wuhan (CN); SAN-YONG YANG, Wuhan (CN); DUN-JUN ZHOU, Wuhan (CN)

(21) Appl. No.: 14/753,622

(22) Filed: Jun. 29, 2015

(30) Foreign Application Priority Data
Jun. 1, 2015 (CN) 201510291447.3

(51) Int. Cl. H01R 13/633

(52) U.S. Cl. CPC H01R 13/633

(57) ABSTRACT

A connector plug includes a main body, a securing base extending from the main body, and an operating member moveably attached to the securing base. The connector plug is used to engage in a socket, and the connector plug is disengaged from the socket by the operating member.

### FIELD

The subject matter herein generally relates to a connector plug.

### BACKGROUND

Racks, frames, and cabinets support electronic components such as computers and other electronic units, e.g., servers, communications switches, patch panels, enclosures and the like. The electronic components can include patch panels, electronic modules, face panels, and the like extending between the vertical members along the front side of the rack. These panels can have slots and other openings for mounting of patch blocks for outlets, adapters, or other devices or to allow access to control portions of the equipment. For example, a patch panel typically comprises a connecting hardware system (e.g., arrays of outlets, ports, or adapters, etc.) that facilitate cable termination, connection, and cabling administration via the use and administration of standard adapters or plugs. These connections are made by cables, cords, or other categories of wires.

### BRIEF DESCRIPTION OF THE DRAWINGS

Implementations of the present technology will now be described, by way of example only, with reference to the attached figures.

FIG. 1 is an exploded, isometric view of a first embodiment of a connector plug.

FIG. 2 is similar to FIG. 1, but viewed from a different angle.

FIG. 3 is a cutaway view of the connector plug of FIG. 1.

FIG. 4 is a top view of the connector plug of FIG. 2, but without an operating member.

FIG. 5 is a top view of a second embodiment of the connector plug, but without the operating member.

FIG. 6 is a top view of a third embodiment of the connector plug, but without the operating member.

FIG. 7 is a top view of a fourth embodiment of the connector plug, but without the operating member.

FIG. 8 is an assembled view of the connector plug of FIG. 1.

FIG. 9 is an assembled view of the connector plug used in a storage device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a connector plug. The connector plug includes a main body, a securing base extending from the main body, and an operating member moveably attached to the securing base. The connector plug is used to engage in a socket, and the connector plug is disengaged from the socket by the operating member.

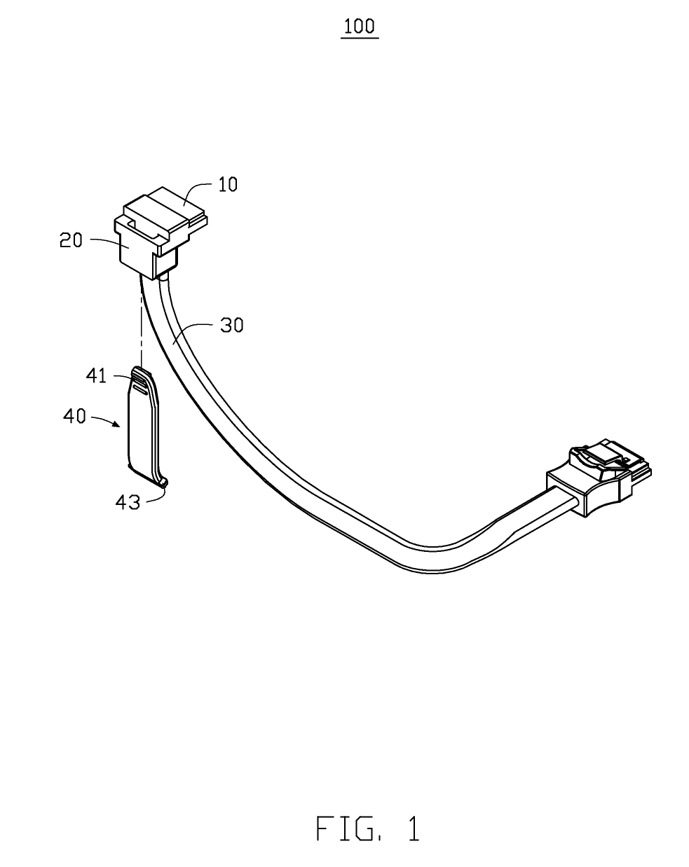

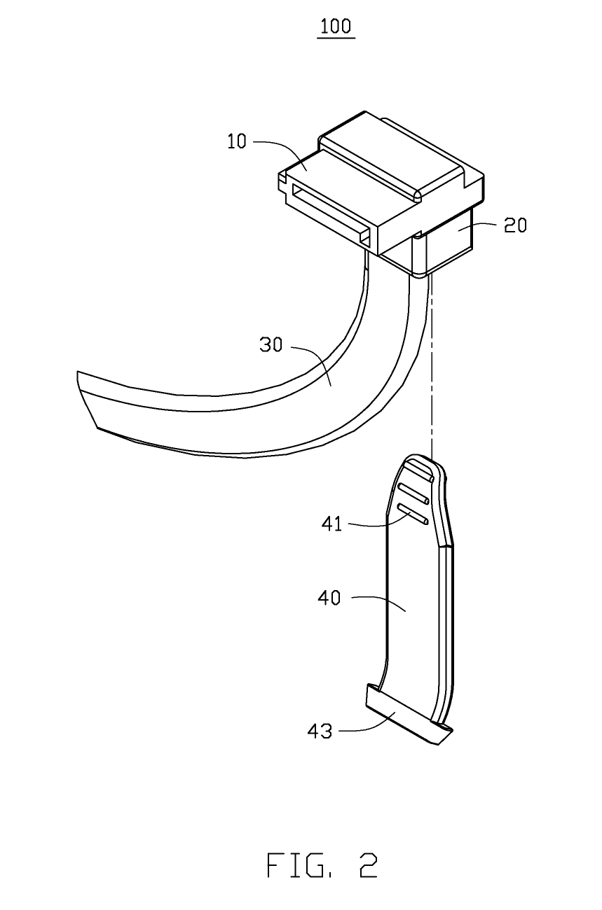

FIG. 1 illustrates an embodiment of a connector plug 100, and FIG. 2 illustrates a different view of the connector plug 100 of FIG. 1. The connector plug 100 can include a main body 10, a securing base 20 extending from the main body 10, a cable 30 coupled to the main body 10, and an operating member 40. The operating member 40 can be slidably attached to the securing base 20. In at least one embodiment, the operating member 40 can be integrated with the securing base 20.

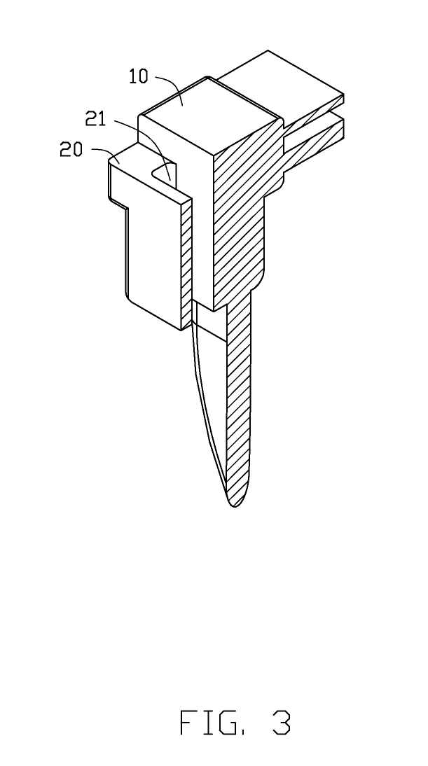

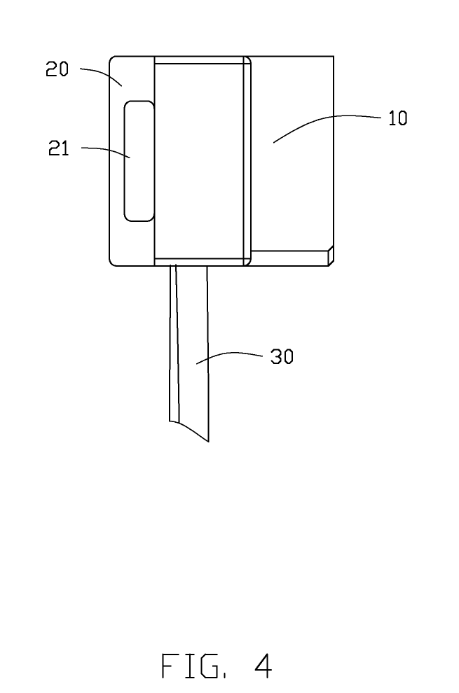

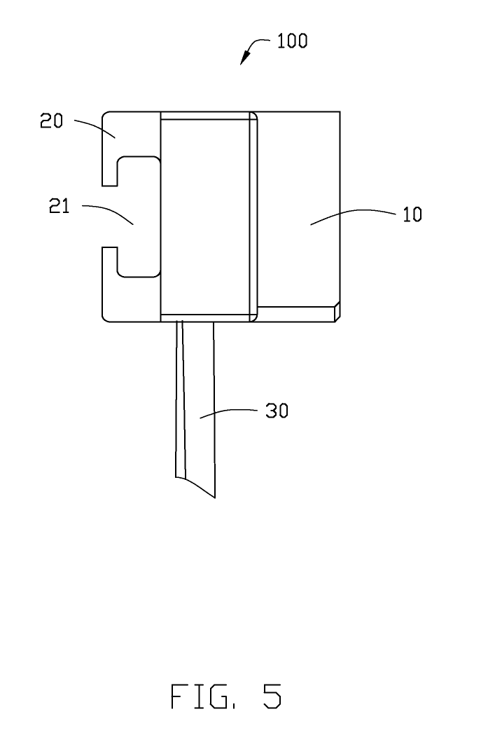

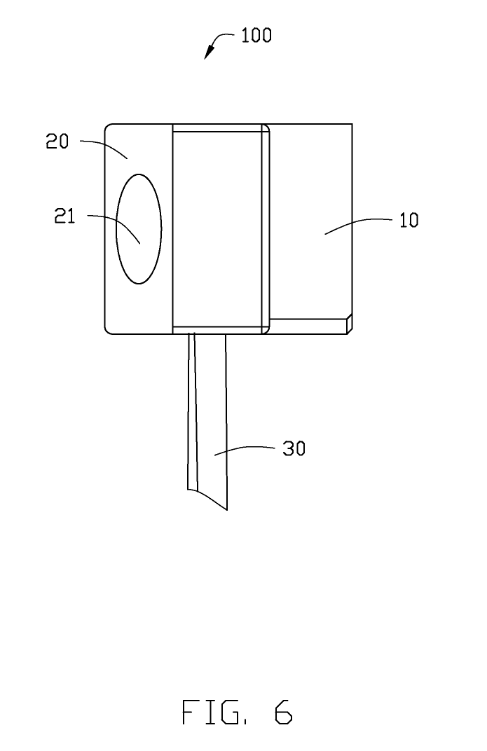

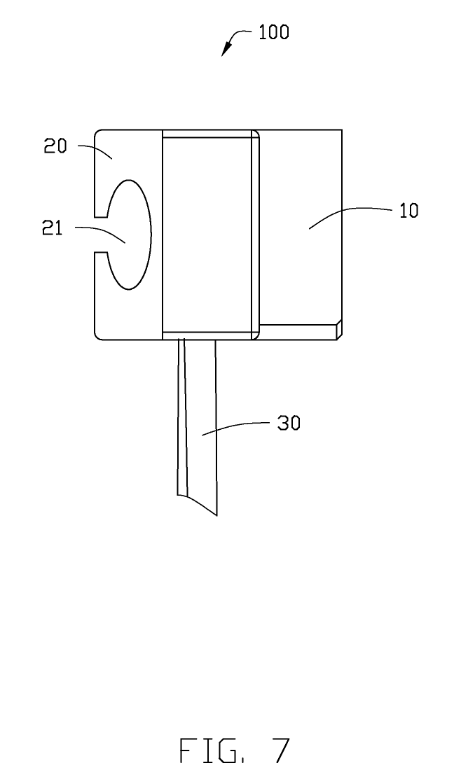

FIG. 3 illustrates the securing base 20 of the connector plug 100. A clipping slot 21 can be defined in the securing base 20 to engage with the operating member 30. In at least one embodiment, the clipping slot 21 extends through the securing base 20 vertically. FIGS. 4 and 6 illustrate the clipping slot 21 can be enclosed. FIGS. 5 and 7 illustrate the clipping slot 21 can be semi-enclosed. In at least one embodiment, the clipping slot 21 can be rectangular (see FIG. 4), or be elliptic (see FIGS. 6-7), or be a circle (not shown).

FIGS. 1 and 2 illustrate the operating member 40 of the connector plug 100. The operating member 40 can be a flexible strip and is substantially arcuate. A blocking portion 41 is located on a first end of the operating member 40 and can be elastic. In at least one embodiment, the blocking portion 41 can include a plurality of ridges arranged in lines. In another embodiment, the block portion 41 can be a concave slot or a protruding portion. For example, when the blocking portion 41 is a concave slot, a limiting portion (not shown) can be located on the securing base 20 to engage in the concave slot for preventing the operating member 40 from disengaging from the clipping slot 21. A clipping portion 43 can be located on a second opposite end of the operating member 40. The clipping portion 43 can be engaged in the clipping slot 21 for preventing the operating member 40 from disengaged from the clipping slot 21. In at least one embodiment, the clipping portion 43 can be a convex platform.

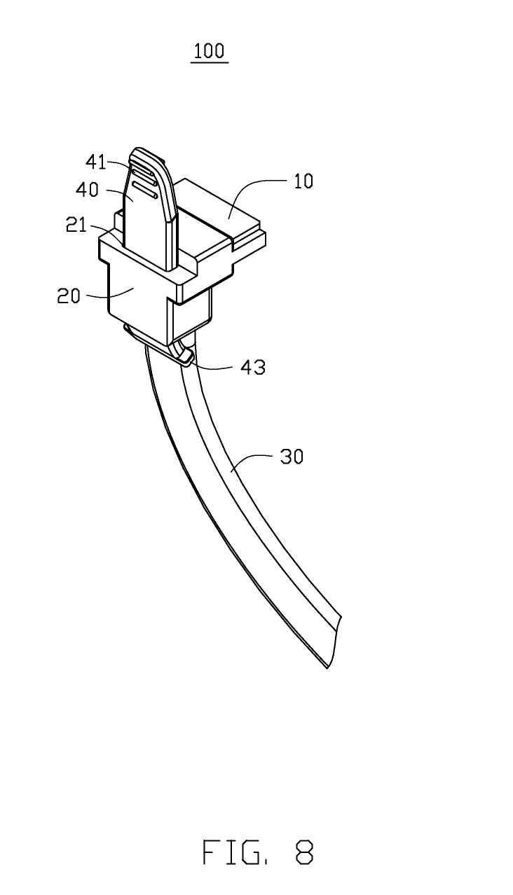

FIG. 8 illustrates an assembled view of the connector plug 100. In assembly, the first end of the operating member 40 is located on a bottom portion of the clipping slot 21 and aligned with the clipping slot 21. The operating member 40 extends through the clipping slot 21 for allowing the clipping portion 43 to abut the cable 30. Therefore, the operating member 40 can be movably engaged in the clipping slot 21 and the first end of the operating member 40 can extend out of the clipping slot 21.

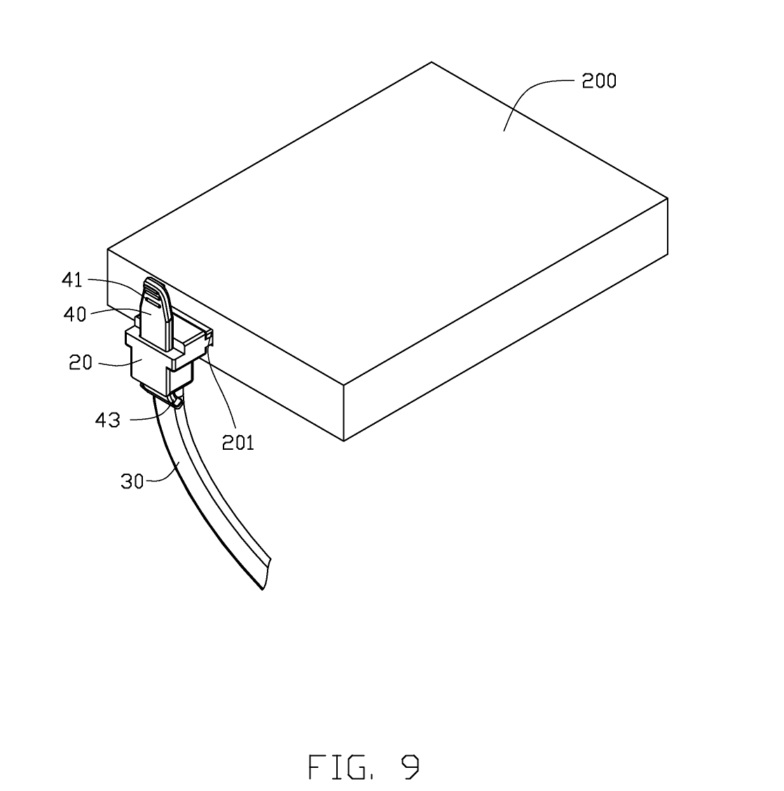

FIG. 9 illustrates when the connector plug 100 is used, the connector plug 100 can be engaged with a socket 201 of a storage device 200. When the connector plug 100 needs to be disengaged from the socket 201, the operating member 40 can be operated to remove the connector plug 100 from the socket 201.

The embodiments shown and described above are only examples. Many details are often found in the art such as the other features of a connector plug. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A connector plug comprising:
a main body;
a securing base extending from the main body; and
an operating member moveably attached to the securing base;
wherein the main body is configured to engage with a socket, and the operating member is configured to disengage the main body from the socket.

2. The connector plug of claim 1, wherein the operating member is integrated with the securing base.

3. The connector plug of claim 1, wherein the securing base defines a clipping slot, and the operating member extends through the clipping slot to be movably engaged in the clipping slot.

4. The connector plug of claim 3, wherein the operating member comprises a clipping portion and a block portion, the clipping portion and the block portion are located on opposite ends of the operating member to prevent the operating member from disengaging from the clipping slot.

5. The connector plug of claim 3, wherein the clipping slot is semi-enclosed or enclosed.

6. The connector plug of claim 3, wherein the clipping slot is rectangular, elliptic, or circle.

7. The connector plug of claim 1, wherein the operating member is substantially arcuate.

8. The connector plug of claim 1, wherein the operating member is a flexible strip.

9. A connector plug comprising:
a main body;
a securing base extending from the main body and defining a clipping slot;
a cable coupled to the main body; and
an operating member extending through the clipping slot and moveably engaged with the clipping slot;
wherein the main body is configured to engage with a socket, and the operating member abuts the cable and is configured to disengage the main body from the socket.

10. The connector plug of claim 9, wherein the operating member comprises a clipping portion and a block portion, the clipping portion and the block portion are located on opposite ends of the operating member to prevent the operating member from disengaging from the clipping slot.

11. The connector plug of claim 9, wherein the clipping slot is semi-enclosed or enclosed.

12. The connector plug of claim 9, wherein the clipping slot is rectangular, elliptic, or circle.

13. The connector plug of claim 9, wherein the operating member is substantially arcuate.

14. The connector plug of claim 9, wherein the operating member is a flexible strip.
